(19) United States
(12) Patent Application Publication
(10) Pub. No.: US 2025/0378014 A1
(43) Pub. Date: Dec. 11, 2025

(54) IMPACT QUOTIENT DETERMINATION FOR PRUNING TEST AUTOMATES

(71) Applicant: SAP SE, Walldorf (DE)

(72) Inventors: Praveen Kumar Jha, Patna (IN); Prakash Kumar, Bangalore (IN); Ravikanth Malipeddu, Bangalore (IN); Prabhat Kumar Singh, Ranchi (IN); Shanavas Madeen S, Krishnagir (IN); Naveen V, Hariharapura (IN); Ajith G, Ernakulam (IN)

(73) Assignee: SAP SE, Walldorf (DE)

(21) Appl. No.: 18/740,317

(22) Filed: Jun. 11, 2024

(51) Int. Cl. G06F 11/36

(52) U.S. Cl. CPC G06F 11/3698

(57) ABSTRACT

As impact quotient for a test automate can be determined and assigned based on factors such as static rules, results of a software analysis of the test automate, results of an analysis of historical data regarding the test automate, and a functional expert opinion. The factors used in the impact quotient determination can be assigned different weights which are adjustable based on the functional expert opinion. A test automate whose assigned impact quotient is below a threshold can be disabled and thus excluded from continuous executions. A test automate whose assigned impact quotient is not below the threshold can maintain an enabled status; updated impact quotients can later be determined for the test automate in response to prompts, in response to which the test automate can either maintain its enabled status or be disabled. Accordingly, low impact test automates can be removed from the pool of continuously executed test automates.

### FIELD

The field generally relates to software testing automation tools.

### BACKGROUND

With the fast-paced development and delivery of innovations, software vendors and consumers rely heavily on automated testing. Automated testing can include the use of robotic process automation (RPA). In this context, test automates can be executed to perform testing in various scenarios such as integration testing, system testing, regression testing, and end-to-end testing before a software release or update. While execution of such test automates help to maintain software quality, the increasing number of test automates in operation has resulted in excessive consumption of scarce infrastructure resources (e.g., cloud-based processing units, virtual machines or docker containers, object storages, databases, etc.) and has increased the overall cost of ownership for software vendors and consumers. Further, not all test automates provide meaningful results. For example, among tens of thousands of test automates which are executed millions of times, there may be a large number of poorly designed, non-valuable test automates that do not provide meaningful or useful information about the quality or functionality of a software application. In addition, some test automates may fail for an extended period without any corrective actions. Continued execution of non-valuable tests consumes valuable infrastructure resources and adds to the load of automated test execution queues, causing delays and hampering overall efficiency.

### BRIEF DESCRIPTION OF THE DRAWINGS

FIG. 1) is a block diagram of an example system implementing impact quotient determination for test automates.

FIG. 2) is a flowchart of an example method of determining an impact quotient for a test automate and either disabling the test automate or maintaining the enabled status of the test automate based on the impact quotient.

FIG. 3) is a flowchart of an example method of determining an impact quotient for a test automate by determining and weighting first, second, third, and fourth preliminary impact quotients.

FIG. 4) is a flowchart of an example method of applying static rules to a test automate to determine the first preliminary impact quotient for the test automate.

FIG. 5) is a flowchart of an example method of performing a software analysis of a test automate to determine the second preliminary impact quotient for the test automate.

FIG. 6) is a flowchart of an example method of performing an analysis of historical data of the test automate to determine the third preliminary impact quotient for the test automate.

FIG. 7) is a flowchart of an example method of determining an updated impact quotient for an edited test automate and either disabling the test automate or maintaining the enabled status of the test automate based on the updated impact quotient.

FIG. 8) is a block diagram of an example user interface displaying a table listing a plurality test automates and respective values of factors which may contribute to impact quotient determinations for the test automates.

FIG. 9) is a block diagram of an example computing system in which described embodiments can be implemented.

FIG. 10) is a block diagram of an example cloud computing environment that can be used in conjunction with the technologies described herein.

### DETAILED DESCRIPTION

### Example 11)—Overview

Test automates are employed at design-time during different stages of software development, as well as run-time in a production environment. For example, during development, test automates may be executed for code changes released as part of a code pipeline. As another example, test automates may be executed at regular intervals to ensure functionality of a given software product is regression-free and that integrating functions works in unison. Such tests include, for example, daily tests, process tests, qualification tests, customer testing for their specific implementations and configuration, content tests, and end-to-end integration tests.

An evaluation process for a test automate can assign an impact quotient to the test automate based on various factors. Lower impact quotients can be assigned to test automates which fail for an extended period without any corrective actions or which are otherwise non-valuable. A test automate whose impact quotient is below a predetermined threshold value can be excluded from continuous executions (e.g., disabled or deleted). A notification can be sent to the owner of the test automate to inform them that the test automate will be excluded from further execution.

Optionally, the notification can include an explanation of why the test automate was assigned a low impact quotient. Accordingly, test automates which are not contributing meaningful results which are commensurate with their resource utilization can be removed (e.g., pruned) from the pool of continuously executed test automates.

The factors used to determine the impact quotient of a test automate can include, for example, static rules, software analysis results, historical data analysis results, and a functional expert opinion. Towards this end, failure rates and associated corrective action for a test automate can be monitored, as well as the depth of functional checks done by the test automate. Functional checks done by an automate can includes the number of actions performed, fields touched, checks performed, imports done, exports done, optional steps performed, system messages captured, etc.

The impact quotient determination can be improved by incorporating the opinion of a functional expert. For example, whereas the other factors contributing to the impact quotient determination may involve no human intervention, a human functional expert may review the other factors (e.g., preliminary impact quotients determined based on the other factors, or a candidate impact quotient determined based on such preliminary impact quotients) and choose to increase or decrease the overall impact quotient based on their learned expertise. Optionally, the functional expert can also choose to modify the weights given to the different factors, including the weight given to the functional expert opinion.

The techniques described herein can be employed for large numbers of test automates. For example, for each test automate among a plurality of test automates, the techniques described herein can include performing a software analysis of the test automate, performing an analysis of historical data of the test automate, and determining an impact quotient of the test automate based on the software analysis of the test automate, the analysis of the historical data of the test automate, and a plurality of static rules. Each rule of the plurality of static rules can specify a condition which, if met for the test automate, either increases or decreases the impact quotient of the test automate. The impact quotient assigned to the test automate can then be compared to an impact quotient threshold. Responsive to the impact quotient being below the impact quotient threshold, a status of the test automate can be modified from enabled to disabled; otherwise, the test automate can maintain its enabled status. During a subsequent automatic testing process (e.g., in response to a prompt issued by a scheduler software module without user intervention), a first subset of the plurality of test automates with an enabled status can be executed and whereas a second subset of the plurality of test automates with a disabled status can be excluded from execution.

By identifying and disabling test automates which have a relatively low impact, the techniques described herein can advantageously reduce infrastructure overload and resource wastage, thereby making the software delivery pipeline more efficient. The described technologies thus offer considerable improvements over conventional automated software testing techniques.

### Example 12)—Example Test Automate

A test automate may be implemented as a software object that includes an automation script. The automation script may be written in a programming language such as Selenium, Tricentis Tosca™, Katalon™, Cypress, or the like. Accordingly, a software object referred to as a test automate can contain computer-readable instructions which, when executed, perform an automated test (e.g., a test which does not require or involve any user interaction). The software object can be an Extensible Markup Language (XML) object, a JavaScript Object Notation (JSON) object, a .Java file, or another type of software object.

As another example, a test automate can be implemented as an object within a framework that supports a keyword-driven approach. In such frameworks, keywords are used to dictate the actions of the test automate, thereby simplifying the process of scripting tests. In either case, a test automate refers to a software object which can be executed on demand in an automated manner, without requiring any user interaction for its functionality.

In some examples, in addition to test automates provided by a software platform, a customer of the software platform may have the capability to use their own automation tools to generate their own test automates. For example, the customer may use automation tools to generate customer-supplied test automates. The technologies described herein for assigning an impact quotient to a test automate can also be applied to such customer-supplied test automates.

### Example 13)—Example Test Case

A given test automate can execute one or more corresponding test cases. A test case refers to a specific scenario composed of a sequence of steps, conditions, and inputs that validate a particular behavior of a software application. Towards this end, a test case may include a test case identifier, a description which explains what the test case will validate, one or more preconditions, one or more test steps (e.g., actions to be performed in the test), and expected results. After execution of a test case, the test case may also include actual results documenting the results of execution of the test case, and status (e.g., pass or fail depending on whether the actual results match the expected results).

One example type of test case that may be executed by the test automates described herein is a test case for user interface (UI) automation. A test case for UI automation can include a set of steps and assertions that validate the behavior and functionality of a UI element or a series of UI interactions. Test cases for UI automation typically involve simulating user actions such as clicking buttons, entering text into input fields, and verifying that the expected outcomes occur.

### Example 14)—Example System Implementing Impact Quotient Determination for Test Automates

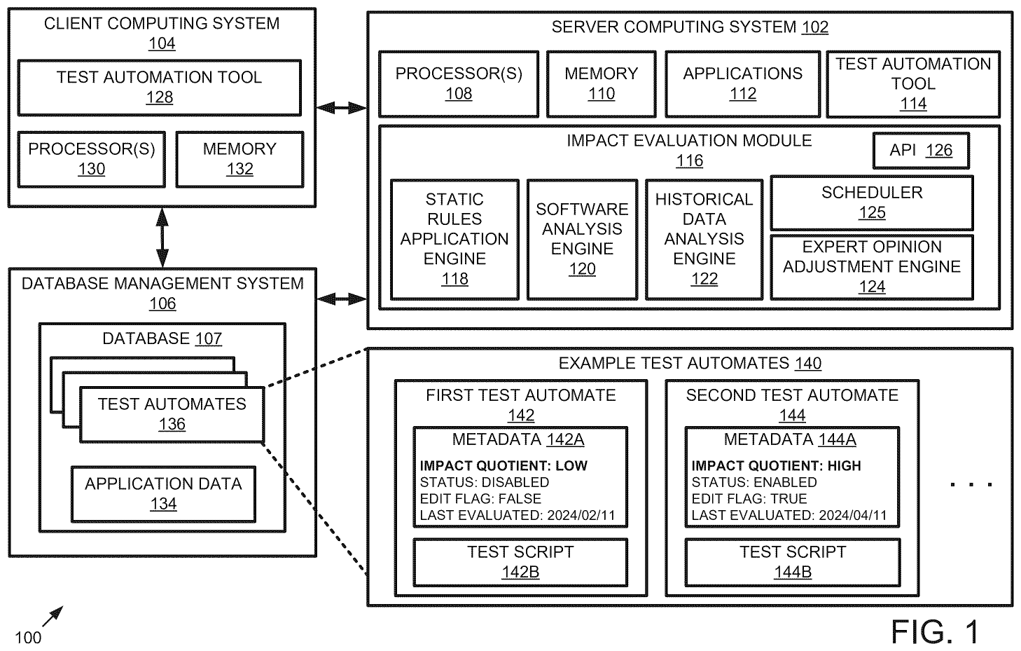

FIG. 1 is a block diagram of an example system 100 implementing impact quotient determination for test automates. In the example, the system 100 includes a server computing system 102, a client computing system, and a database management system 106 including a database 107. While a single instance of each system is depicted for ease of explanation, system 100 may include multiple server computing systems, client computing systems, and/or database management systems in practice.

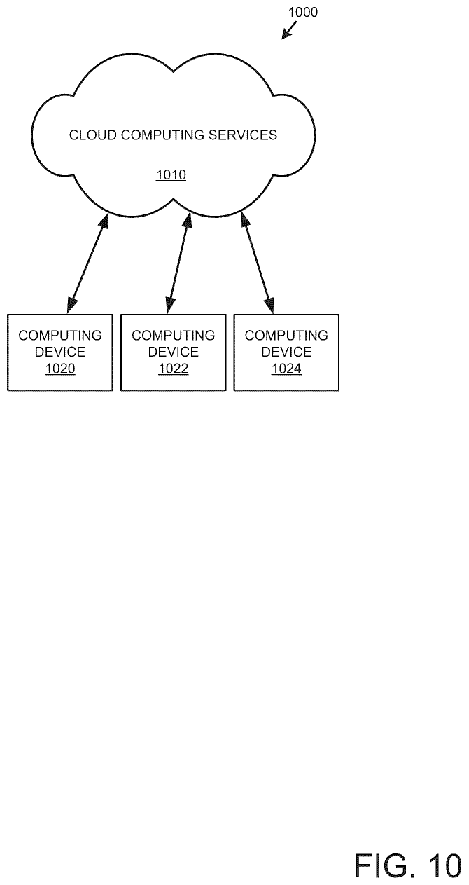

Any of the systems herein, including the system 100, can comprise at least one hardware processor and at least one memory coupled to the at least one hardware processor. In some examples, two or more elements of system 100 are implemented by a single computing device and/or two or more elements of system 100 are co-located. Further, one or more elements of system 100 can be implemented in a cloud computing environment, as described further below with reference to FIG. 10.

In the example, server computing system 102 includes processor(s) 108, memory 110, applications 112, a test automation tool 114, and an impact evaluation module 116 for assigning impact quotients to test automates. Server computing system 102 can include an on-premises server, a cloud-deployed virtual machine, or another suitable type of computing system which can provide the functions described herein. Applications 112 can include server-side executable program code (e.g., compiled code, scripts, etc.) executing within the server computing system 102 to receive queries/requests from clients, via client computing system 104, and provide results to the clients based on the data of database 107.

Test automation tool 114 can be a proprietary test automation tool or a third-party automation tool which is used to generate and/or adapt test automates. Some examples of third-party automation tools that may be used in this context include Selenium, Katalon Studio™, Puppeteer™, Protractor, Tricentis Tosca™, and Cypress.

In the example, impact evaluation module 116 is a software module that includes a static rules application engine 118, a software analysis engine 120, a historical data analysis engine 122, an expert opinion adjustment engine 124, a scheduler 125, and an Application Programming Interface (API) 126. In practice, the various engines may alternatively be combined or implemented external to the impact evaluation module 116 (e.g., implemented via one or more of applications 112, or implemented external to server computing system 102). Additionally or alternatively, the functionality of one or more of the engines may be performed by a third party service.

As detailed herein, the static rules application engine 118 may include computer-executable instructions that, when executed, perform operations to apply a plurality of static rules to a given test automate and determine whether the test automate meets the rules. The results of this determination can serve as a first preliminary impact quotient for the test automate, which in turn can be combined with other preliminary impact quotients by the impact evaluation module 116 to determine an overall impact quotient for the test automate.

The software analysis engine 120 may include computer-executable instructions that, when executed, perform operations to analyze a given test automate (e.g., analyze the test script within the test automate) and assign a second preliminary impact quotient for the test automate based on the results of the analysis. Similarly, the historical data analysis engine 122 may include computer-executable instructions that, when executed, perform operations to analyze historical data pertaining to a given test automate (e.g., historical performance data regarding one or more prior executions of the test automate) and assign a third preliminary impact quotient for the test automate based on the results of the analysis.

The expert opinion adjustment engine 124 may include computer-executable instructions that, when executed, perform operations to obtain an opinion from a functional expert regarding the impact of the test automate and assign a fourth preliminary impact quotient for the test automate based on the expert opinion. Optionally, the expert opinion adjustment engine 124 can also perform operations to adjust one or more weights assigned to various factors considered by the impact evaluation module 116 in determining the impact quotient for the test automate (e.g., the weights assigned to one or more of the preliminary impact quotients).

The scheduler 125 can be implemented as a software module that includes computer-executable instructions that, when executed, perform operations for scheduling evaluation and re-evaluation of test automates. For example, the scheduler can be configured to perform checks at predetermined intervals (e.g., daily, weekly, monthly, or other intervals) to determine which test automates have been edited. In addition, the scheduler can be configured to evaluate/re-evaluate all test automates, or a subset of test automates, in response to events such as software releases, software updates, etc.

API 126 can provide an interface through which different software applications can interact with the impact evaluation module 116. For example, users of server computing system 102 (e.g., administrative users or developers) can interact with impact evaluation module 116 via API 126 to obtain impact quotients for test automates and related data (e.g., data including details on the factors that contributed to the impact quotient). As another example, the impact evaluation module 116 may communicate with a user of client computing system 104 via API 126 to notify the user that a test automate owned by the user has been disabled after being assigned a low impact quotient.

The client computing system 104 includes a test automation tool 128 along with processor(s) 130 and memory 132. Client computing system 104 can also include other components (e.g., applications) which are not depicted in the example for the sake of brevity. Client computing system 104 may be a computing system operated by a customer of a software platform. As shown, client computing system communicates with server computing system 102 and database management system 106 (e.g., via a wired or wireless connection).

Similar to test automation tool 114, test automation tool 128 can be a proprietary test automation tool or a third-party automation tool which a user of client computing system 104 uses to generate and/or adapt test automates. Such test automates may be referred to herein as customer-owned or client-owned test automates.

In the example, database management system 106 includes database 107; other components may also be included in database management system 106. Database 107 includes application data 134 and a plurality of test automates 136. Application data 134 can include data defining objects accessible by applications 112 of server computing system 102, and/or applications executing on the client computing system 104.

The test automates 136 stored in database 107 can include one or more test automates generated by test automation tool 114 (e.g., server-owned test automates) and/or one or more test automates generated by test automation tool 128 (e.g., client-owned test automates). In practice, the database 107 may store a large number of test automates at any given time (e.g., tens of thousands of test automates or more).

Example test automates 140, which can be examples of test automates 136, are depicted for illustrative purposes. Example test automates 140 include a first test automate 142 and a second test automate 144; as suggested by the ellipsis mark, the database would typically store a large quantity of test automates. In the example, first test automate 142 includes metadata 142A and test script 142B. Metadata 142A includes bibliographical data for the first test automate 142; as shown, this can include an indication of an impact quotient assigned to the first test automate 142, a current status of the first test automate 142, a value of an edit flag for the first test automate 142, and a last evaluated date of the first test automate 142. Test script 142B of test automate 142 includes test script (e.g., code) that can be executed to perform a first automated test.

Similarly, in the example, second test automate 144 includes metadata 144A and test script 144B. Metadata 144A includes bibliographical data for the second test automate 144; as shown, this can include an indication of an impact quotient assigned to the second test automate 144, a current status of the second test automate 144, a value of an edit flag for the second test automate 144, and a last evaluated date of the second test automate 144. Test script 144B of test automate 144 includes test script (e.g., code) that can be executed to perform a second automated test.

As shown, the first test automate 142 has been assigned a low impact quotient by the impact evaluation module 116, which is included in metadata 142A. In practice, a more specific impact quotient may be assigned, such as a numerical value or a percentage. Alternatively, the impact quotient assigned to a test automate may be stored elsewhere and not included in its metadata. Metadata 142A also indicates that the status of first test automate 142 is disabled; for example, the impact evaluation module 116 may send a command to the database management system 106 to change the status of the first test automate 142 from enabled to disabled after assigning a low impact quotient (e.g., an impact quotient below a predetermined threshold) to the first test automate 142. Alternatively, a status change of a test automate may be effected in a different manner (e.g., the test automate may be deleted rather than disabled, moved to a different area of storage reserved for inactive test automates, etc.).

Metadata 142A also includes an edited flag. In the example, the edited flag has a value of False, indicating that the first test automate 142 has not been edited since its last impact quotient determination. The value of the last evaluated date shown in metadata 142A (Feb. 11, 2024) represents the date of the last impact quotient determination for the first test automate 142. In practice, the last evaluated date field may also include the time at which the test automate was evaluated on the specified date.

In contrast, the second test automate 144 has been assigned a high impact quotient (e.g., an impact quotient above a predetermined threshold) by the impact evaluation module 116, which is included in metadata 144A. Metadata 144A also indicates that the status of second test automate 144 is enabled; for example, the status of second test automate may not be modified after it has been assigned the high impact quotient, such that the second test automate 144 remains enabled and continues to be executed.

In the example, the edited flag of second test automate 144 has a value of True, indicating that the second test automate 144 has been edited since its last impact quotient determination. Accordingly, an updated impact quotient will be determined for the second test automate 144 when the impact evaluation module 116 next receives a prompt to re-evaluate test automates (e.g., at a predetermined interval, in response to an event such as a software update or release, etc.). The value of the last evaluated date shown in metadata 144A indicates that the second test automate 144 was last evaluated on Apr. 11, 2024; accordingly, it can be assumed that an impact quotient determination was performed for the second test automate at least once since the first test automate 142 was disabled.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the server computing system 102, client computing system 104, and database management system 106 can each include additional components and complexity.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the impact evaluation module 116, the test automates 136, and the like can be stored in one or more computer-readable storage media or computer-readable storage devices. The technologies described herein can be generic to the specifics of operating systems or hardware and can be applied in any variety of environments to take advantage of the described features.

### Example 5—Example Method of Assigning an Impact Quotient to a Test Automate and Disabling a Low Impact Quotient Test Automate

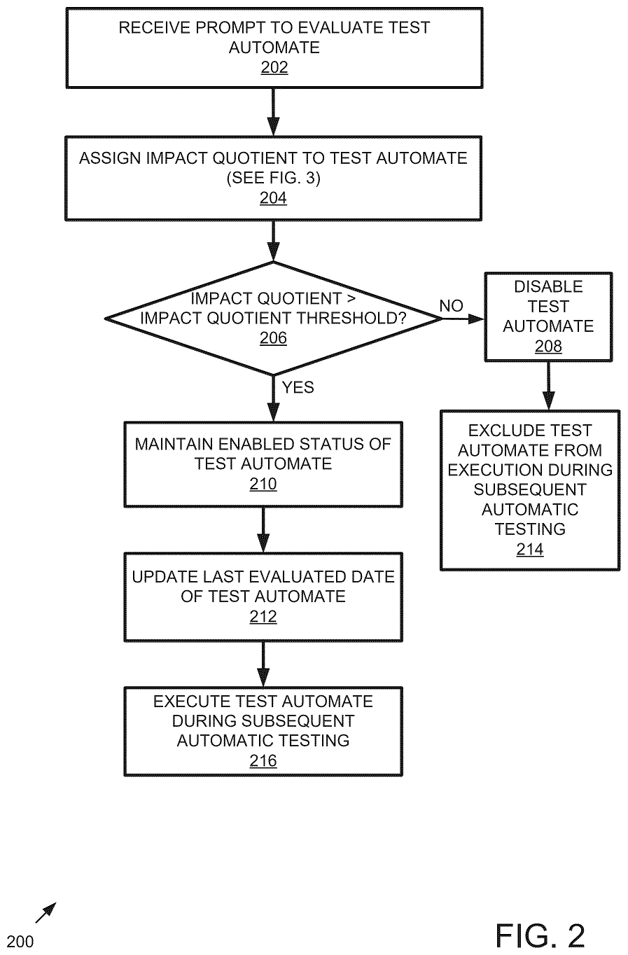

FIG. 2 is a flowchart of an example method 200 of determining an impact quotient for a test automate and either disabling the test automate or maintaining the enabled status of the test automate based on the impact quotient and can be performed, for example, by the system of FIG. 1.

In the example, at 202, a prompt to evaluate a test automate is received. For example, the impact evaluation module of a server computing system may receive a prompt (e.g., a request) to evaluate the test automate from a scheduler (e.g., scheduler 125 of FIG. 1), from a user via an API (e.g., API 126 of FIG. 1), or from another source. Optionally, the prompt may include an indication of why an impact quotient determination is being requested for the test automate, among other data.

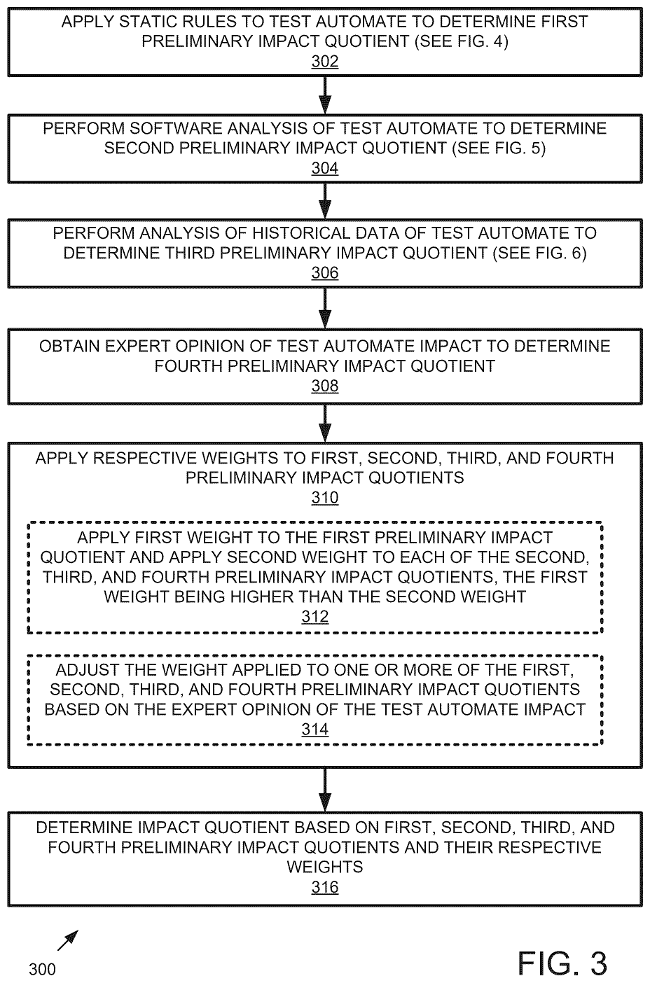

At 204, an impact quotient is assigned to the test automate. An example process for assigning the impact quotient to a test automate is described below with reference to FIG. 3.

At 206, the method includes determining whether the impact quotient assigned to the test automate is greater than an impact quotient threshold. The impact quotient threshold can be stored in a table or other data structure and retrieved from the table at the time of the determination. The value of the impact quotient threshold may have a static predefined value; alternatively, the value of the impact quotient threshold may be dynamically configurable by a user (e.g., an administrative user or functional expert). The value of the impact quotient threshold may depend on the format in which the impact quotient is expressed (e.g., a numerical value, a percentage, etc.). Alternatively, in examples where the assigned impact quotient has a binary value (e.g., either 0 or 1 representing low or high, respectively), determining whether the impact quotient is greater than the impact quotient threshold may include determining whether the impact quotient is equal to one of the binary values that represents a high impact quotient.

If the answer at 206 is NO, indicating that the assigned impact quotient for the test automate is not greater than the impact quotient threshold, the method proceeds to 208 to disable the test automate. As described herein, this can include, for example, modifying the metadata of the test automate to change its status from enabled to disabled, deleting the test automate, or removing the test automate from a repository of currently active test automates. After disabling the test automate, the method proceeds to 214 and the test automate is excluded from execution during subsequent automatic testing.

Otherwise, if the answer at 206 is YES, indicating that the assigned impact quotient for the test automate is greater than the impact quotient threshold, the method proceeds to 210 to maintain the enabled status of the test automate. In some examples, this may include taking no action. In other examples, maintaining the enabled status of the test automate may include updating the metadata of the test automate accordingly (e.g., updating the metadata of the test automate to list the assigned impact quotient), or taking another action.

After 210, the method proceeds to 212 to update the last evaluated date of the test automate. For example, this can include updating the metadata of the test automate to populate a last evaluated date field with the date (and optionally, time) the impact quotient was assigned. In other examples, updating the last evaluated date of the test automate can occur in another way (e.g., by updating a data structure external to the test automate. After 212, the method proceeds to 216. At 216, the test automate is executed during subsequent automatic testing.

Method 200 may be performed iteratively for a plurality of test automates. For example, the prompt received at 202 may specify a plurality of test automates which are to receive impact quotient assignments, and method 200 may be performed for each of the specified test automates (e.g., in parallel or consecutively).

Accordingly, after method 200 is performed for one or more test automates, any test automates that were disabled at step 208 may be excluded from subsequent automated testing. For example, method 200 may be performed iteratively for a first test automate and a second test automate, resulting in the first test automate being disabled and the second test automate retaining its enabled status. Subsequently, an automated testing process may be automatically initiated (e.g., after a predetermined time period has elapsed, or in response to an event such as a software release or update). During this automated testing process, the first test automate is excluded due to its disabled status and thus is not executed, thereby reducing unnecessary use of computing resources, whereas the second test automate is included due to its enabled status and is executed.

As used herein, references an automated testing process can be understood as referring to a process which is initiated and performed without human intervention (e.g., solely by a computing system). For example, a server computing system such as server computing system 102 of FIG. 1 may include non-transitory computer-readable media storing instructions that, when executed, initiate and perform an automated testing process. Alternatively, another computing system or component of a computing system can initiate and/or perform the automated testing process.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a prompt can be described as sending a prompt depending on perspective.

### Example 6—Example Method of Determining Impact Quotient for Test Automate

FIG. 3 is a flowchart of an example method 300 of determining an impact quotient for a test automate by determining and weighting first, second, third, and fourth preliminary impact quotients and can be performed, for example, by the system of FIG. 1 in conjunction with the method of FIG. 2. For example, as indicated, method 300 can be performed at step 204 of FIG. 2 to determine an impact quotient to be assigned to a test automate, which can then be compared to a threshold to determine whether to disable the test automate or maintain its enabled status.

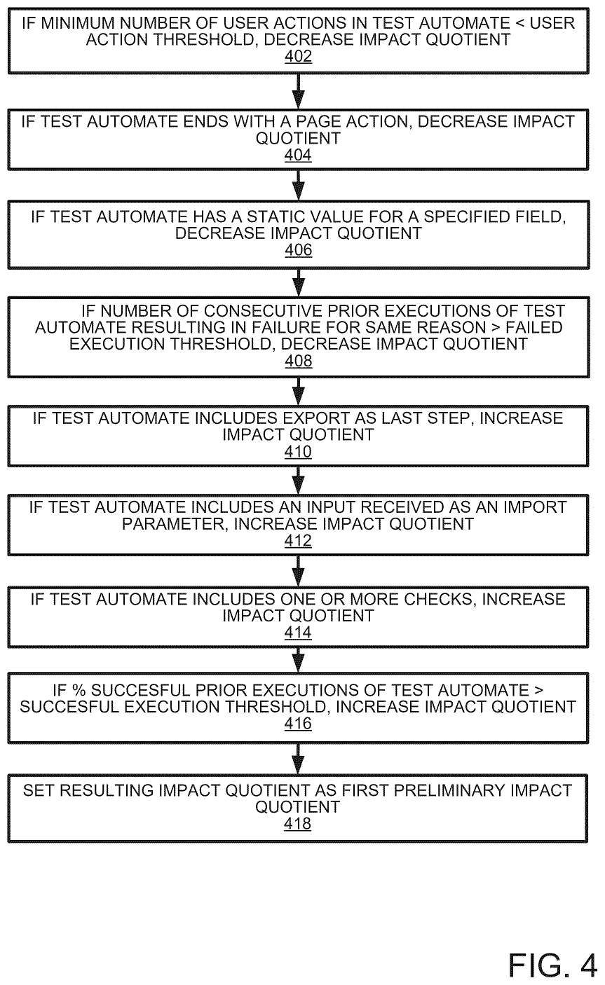

In the example, at 302, static rules are applied to the test automate to determine a first preliminary impact quotient. An example process for determining the first preliminary impact quotient is described below with reference to FIG. 4.

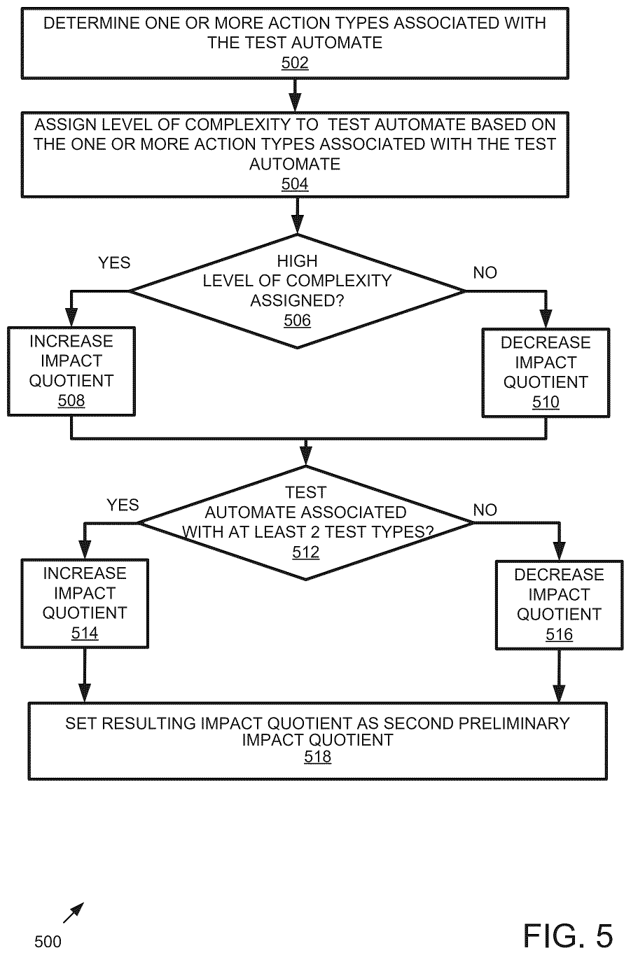

At 304, a software analysis of the test automate is performed to determine a second preliminary impact quotient. An example process for determining the second preliminary impact quotient is described below with reference to FIG. 5.

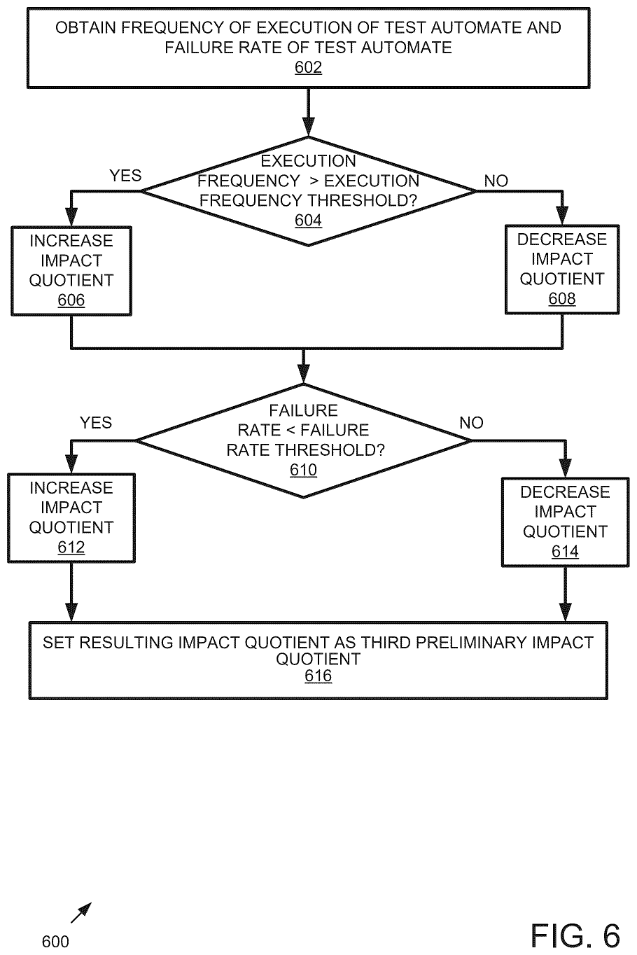

At 306, an analysis of historical data of the test automate is performed to determine a third preliminary impact quotient. An example process for determining the third preliminary impact quotient is described below with reference to FIG. 6.

At 308, an expert opinion of the impact of the test automate is obtained to determine a fourth preliminary impact quotient. For example, a request can be transmitted, via an API, to a client computing system associated with a user with relevant functional expertise (referred to herein as an expert or functional expert). The functional expert can evaluate the test automate and optionally, one or more of the preliminary impact quotients. Based on this information, the functional expert can determine a fourth preliminary impact quotient for the test automate. In some examples, the determination of the fourth preliminary impact quotient can be based at least in part on a recommendation by the expert to manually adjust the impact quotient to improve its accuracy. Manual adjustment of the impact quotient can include increasing or decreasing the impact quotient by an amount specified by the functional expert within the specified weightage relevant for manual adjustment.

Optionally, the functional expert may also provide feedback to the impact quotient assignment system regarding adjustments to the various factors which would improve the accuracy of future impact quotient assignment processes (e.g., adjustment of the weight of one or more factors, etc.).

After 308, the method proceeds to 310 to apply respective weights to the first, second, third, and fourth preliminary impact quotients. This can optionally include, at 312, applying a first weight to the first preliminary impact quotient, and applying a second weight to each of the second, third, and fourth impact quotients, the first weight being higher than the second weight. For example, the application of the static rules to the test automate may provide an especially accurate assessment of the impact quotient of a test automate; accordingly, a relatively high weight (e.g., 70%) may be applied to the first preliminary impact quotient. On the other hand, the other factors (e.g., software analysis, historical data analysis, and expert opinion) may be considered less important for the impact quotient determination; accordingly, relatively low weights (e.g., 10% each) may be assigned to these factors. In other examples, other weight combinations may alternatively be used which add up to 100%.

As shown, step 310 can also optionally include, at 314, adjusting the weight applied to one or more of the first, second, third, and fourth preliminary impact quotients based on the expert opinion of the test automate impact that was obtained at 308. For example, the functional expert can increase or decrease the weight applied to one or more of the first, second, third, and fourth preliminary impact quotients. Accordingly, defects or inaccuracies in the static rules, software analysis, or historical data can be remedied by permitting manual modification of the weight applied to these factors by a functional expert.

After 310, the method proceeds to 316 to determine the impact quotient based on the first, second, third, and fourth preliminary impact quotients and their respective weights. For example, this can include the impact evaluation module performing an algorithm that adjusts numerical values of the first, second, third, and fourth preliminary impact quotients based on their assigned weights and then calculates an overall impact quotient for the test automate as the summation of the resulting preliminary impact quotients

### Example 7—Example Method of Applying Static Rules to a Test Automate

FIG. 4 is a flowchart of an example method 400 of applying static rules to a test automate to determine a first preliminary impact quotient for the test automate and can be performed, for example, by the system of FIG. 1 in conjunction with the method of FIGS. 2 and 3. For example, as indicated, method 400 can be performed at step 302 of FIG. 3 to determine an first preliminary impact quotient for a test automate, which can factor into the determination of an overall impact quotient for the test automate. The static rules can be applied by a static rules application engine (e.g., static rules application engine 118 of FIG. 1), or by another entity.

For ease of explanation, the steps of method 400 refer to decreasing or increasing the impact quotient in response to various conditions being met. In practice, the actual action take in response to one of the conditions being met may be different. For example, each of the static rules may be assigned a value (e.g., a value between one and ten); when the condition associated with the rule is met, the value assigned to the rule may be higher than the value assigned to the rule when the condition associated with the rule is not met. For example, depending on the rule, the extent to which the test automate meets or does not meet the condition associated with the rule may lead to a greater increase or decrease to the impact quotient (or to the value assigned to the rule, which ultimately contributes to determination of the first preliminary impact quotient).

In the example, at 402, the impact quotient is decreased if the minimum number of user actions in the test automate is less than a user action threshold. In particular, some test automates may simulate user actions such as button clicks and entry of data into fields on a UI. When the user actions in a test automate include less than three steps, the test automate typically has a relatively low impact, e.g., as it may lack verification of the results of the action it is testing. As an illustrative example, a test automate simulating a user web search may include a first user action of clicking in a search field, a second user action of entering data in the search field, and a third user action of clicking a search button. If the test automate only includes these three actions, and does not include additional actions (e.g., to verify that the search has been performed and has returned results), it may be considered to have a low impact.

At 404, the impact quotient is decreased if the test automate ends with a page action. The page action can be, for example, an action which changes the UI base such as Go, Save, or Post and then ends. When a test automate ends with a page action that is not followed by a check, the test automate tends to have a low impact. As used herein, a check may refer to an assertion of the test automate which ensures that the desired application state is present. The check that follows the page action can be a value check (e.g., a check which determines whether an expected value appears after an action has been performed) or a UI check (e.g., a check which validates whether the state of the UI is an expected state after an action has been performed, e.g., a save button being disabled after a save action has been performed).

For example, when a sales order creation function is tested manually, the last step would be saving a sales order which saves the associated object. After clicking on “save” on the UI, a message will pop up indicating that the sales order was saved and thus serves as confirmation that the sales order was created. If a test automate ends with a page action such as save, it does not confirm that the save was actually performed correctly as it stops before checking for the confirmation of the save (e.g., the pop up message). Accordingly, such a test automate may incorrectly indicate that the save was performed successfully, even when there may be a bug in the sales order creation functionality which prevented the save from occurring. Accordingly, a test automate which ends with a page action and does not perform a check after performing the page action may have a relatively low impact, as the test does not comprehensively validate whether the page action actually occurred.

At 406, the impact quotient is decreased if the test automate has a static value for a specified field. Such test automates may have high probability of failure and thus a low impact. For example, during creation of sales order in an enterprise application, entry of a current date may be required. However, the test case associated with a test automated may be created a static value for the current date. As a result, subsequent executions of the test case will fail as they will attempt to create the sales order with the previous date due to the current date field being static. Accordingly, in such cases it is important to provide the current date every time the test automate runs. Thus, test automates whose code includes any statically coded dates field tend to have a relatively low impact, whereas test automates whose code includes only dynamically coded date fields are associated with a higher impact.

At 408, if a number of consecutive prior executions of the test automate that resulted in failure for a same reason is greater than a failed execution threshold, the impact quotient is decreased for the test automate. A test automate with a relatively high number of consecutive executions that resulted in failures (e.g., ten or more) may have a lower impact than a test automate with a lower number of consecutive executions that resulted in failures. In particular, a relatively high number of consecutive executions that have resulted in failures may indicate that a user noticed the failure but did not act, which indicates that the user did not consider the test automate to be very impactful.

At 410, the impact quotient is increased if the test automate ends with an export as the last step. At 412, the impact quotient is increased if the test automate receive inputs as import parameters. Such test automates may have a relatively high impact, as the associated test cases may be consumed in an end-to-end process test. For example, such test automates may be chained together.

At 414, the impact quotient is increased if the test automate includes one or more checks.

At 416, the impact quotient is increased if the test automate has a percentage of successful prior executions greater than a successful execution threshold.

At 418, the resulting impact quotient (e.g., the impact quotient determined based on the various increases and decreases performed in steps 402-416) is set as the first preliminary impact quotient. The first preliminary impact quotient can then be considered in conjunction with other factors to determine an overall impact quotient for the test automate.

In other examples, the various static rules may contribute the overall impact quotient determination in different way. In addition, fewer or more static rules than those depicted may be considered.

### Example 8—Example Method of Performing a Software Analysis of a Test Automate

FIG. 5 is a flowchart of an example method 500 of applying static rules to a test automate to determine a first preliminary impact quotient for the test automate and can be performed, for example, by the system of FIG. 1 in conjunction with the method of FIGS. 2 and 3. For example, as indicated, method 500 can be performed at step 304 of FIG. 3 to determine a second preliminary impact quotient for a test automate, which can factor into the determination of an overall impact quotient for the test automate. The software analysis can be performed by a software analysis engine (e.g., software analysis engine 120 of FIG. 1), or by another entity.

In the example, at 502, one or more action types associated with the test automate are determined. At 504, a level of complexity is assigned to the test automate based on the one or more action types associated with the test automate. For example, test automates that have a low level of complexity may include test automates that include only click actions and test automates that include a high percentage of optional steps (e.g., more than 50% of the steps are optional).

At 506, it is determined whether a high level of complexity was assigned to the test automate. If the answer at 506 is YES, the method proceeds to 508 to increase the impact quotient of the test automate. Otherwise, if the answer at 506 is NO, the method proceeds to 510 to decrease the impact quotient of the test automate. After 508 or 510, the method proceeds to 512.

At 512, it is determined whether the test automate is associated with at least two test types (e.g., with reusable test cases). For example, when a test automate is associated with a test case that is used for two different types of testing (e.g., for Language Acceptance Testing as well as functional testing), the test automate can be considered to have a relatively high impact. Accordingly, if the answer at 512 is YES, indicating that the test automate is associated with at least two test types, the method proceeds to 514 to increase the impact quotient of the test automate. Otherwise, if the answer at 512 is NO, the method proceeds to 516 to decrease the impact quotient of the test automate. After 514 or 516, the method proceeds to 518.

At 518, the resulting impact quotient (e.g., the impact quotient resulting from the various increases and/or decreases) is set as the second preliminary impact quotient. The second preliminary impact quotient can then be considered in conjunction with other factors to determine an overall impact quotient for the test automate.

In other examples, the second preliminary impact quotient may take into account different factors (e.g., more or fewer factors than those depicted in FIG. 5).

### Example 9—Example Method of Performing an Analysis of Historical Data of a Test Automate

FIG. 6 is a flowchart of an example method 600 of performing an analysis of historical data of the test automate to determine the third preliminary impact quotient for the test automate and can be performed, for example, by the system of FIG. 1 in conjunction with the method of FIGS. 2 and 3. For example, as indicated, method 600 can be performed at step 306 of FIG. 3 to determine a third preliminary impact quotient for a test automate, which can factor into the determination of an overall impact quotient for the test automate. The historical data analysis can be performed by a historical data analysis engine (e.g., historical data analysis engine 122 of FIG. 1), or by another entity. The historical data used in the historical data analysis can be obtained from a database, such as an Advanced Business Application Programming (ABAP) database.

In the example, at 602, a frequency of execution of the test automate and a failure rate of the test automate are obtained.

At 604, it is determined whether the execution frequency of the test automate is greater than an execution frequency threshold. If the answer at 604 is YES, the method proceeds to 606 to increase the impact quotient of the test automate. Otherwise, if the answer at 604 is NO, the method proceeds to 608 to decrease the impact quotient of the test automate. After 606 or 608, the method proceeds to 610.

At 610, it is determined whether the failure rate of the test automate is greater than a failure rate threshold. For example, if a test automate has experienced repeated failures which have not been acted on (e.g., by disabling or editing the test automate), the test automate can be assumed to have a low impact.

If the answer at 610 is YES, the method proceeds to 612 to increase the impact quotient of the test automate. Otherwise, if the answer at 610 is NO, the method proceeds to 614 to decrease the impact quotient of the test automate. After 612 or 614, the method proceeds to 616.

At 616, the resulting impact quotient (e.g., the impact quotient resulting from the various increases and/or decreases) is set as the third preliminary impact quotient. The third preliminary impact quotient can then be considered in conjunction with other factors to determine an overall impact quotient for the test automate.

In other examples, the third preliminary impact quotient may take into account different factors (e.g., more or fewer factors than those depicted in FIG. 6).

### Example 10—Example Method of Assigning an Updated Impact Quotient to a Test Automate and Disabling a Low Updated Impact Quotient Test Automate

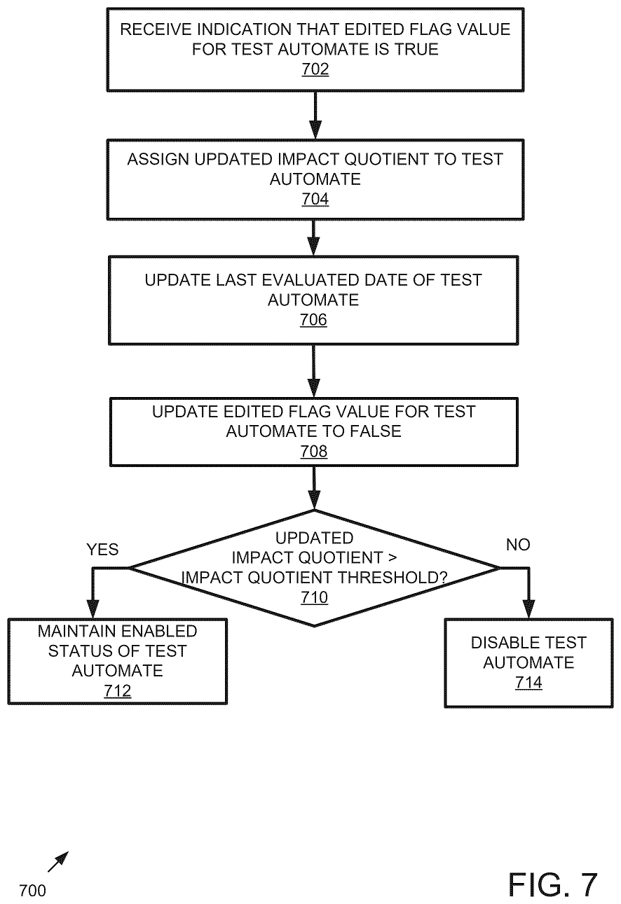

FIG. 7 is a flowchart of an example method 700 of determining an updated impact quotient for an edited test automate and either disabling the test automate or maintaining the enabled status of the test automate based on the updated impact quotient. Method 700 can be performed, for example, by the system of FIG. 1 in conjunction with the method of FIG. 3. For example, method 300 can be performed at step 704 of FIG. 7 to determine the updated impact quotient.

For example, after an initial impact quotient is assigned to a test automate, the test automate may be modified (e.g., by adding additional checks, user clicks, etc.). Editing of the test automate may trigger an update of the edited flag of the test automate (e.g., setting of the value of the edited flag to True). The scheduler of the impact evaluation module may perform checks at predetermined intervals (e.g., daily) to determine which test automates have an edited flag with a value of True. The impact evaluation module can then recalculate the impact quotient for the edited test automates, assign the new impact quotients to the corresponding test automates, and modify the values of their last evaluated date fields accordingly. The system can also set an edited flag for each of the re-evaluated test automates as False so that the scheduler does not attempt to re-evaluate them again before they have received another edit.

Accordingly, a user wishing to increase the impact quotient of a given test automate can edit the test automate with this goal. The editing of the test automate triggers re-evaluation by the scheduler (e.g., within a day if the scheduler checks for edited test automates once per day), and the assigned impact quotient will be modified based on the user's edits to the test automate.

In the example, at 702, an indication is received (e.g., from a scheduler such as scheduler 125 of FIG. 1) that an edited flag of the test automate has a value of True, indicating that the test automate has been edited.

Alternatively, the indication may simply indicate that the test automate requires re-evaluation (e.g., the indication may be triggered by an event other than editing of the test automate). For example, the impact quotient assigned to a given test automate may be re-evaluated at predetermined intervals or in response to certain events. For example, test automates may be re-evaluated prior to a scheduled software update or release. In some examples, such updates or releases may occur at predefined intervals (e.g., monthly or every six months).

At 704, an updated impact quotient is assigned to the test automate, e.g., in the manner described above with reference to FIG. 3.

At 706, the last evaluated date of the test automate is updated with the current date (and optionally, time).

At 708, the edited flag of the test automate is updated to False (e.g., to avoid re-evaluation being triggered by the scheduler before another edit has occurred).

At 710, it is determined whether the updated impact quotient is greater than an impact quotient threshold. If the answer at 710 is YES, the method proceeds to 712 to maintain the enabled status of the test automate. Otherwise, if the answer at 710 is NO, the method proceeds to 714 to disable the test automate (e.g., prevent further execution of the test automate).

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 11—Example User Interface Displaying Factors for Impact Quotient Determination

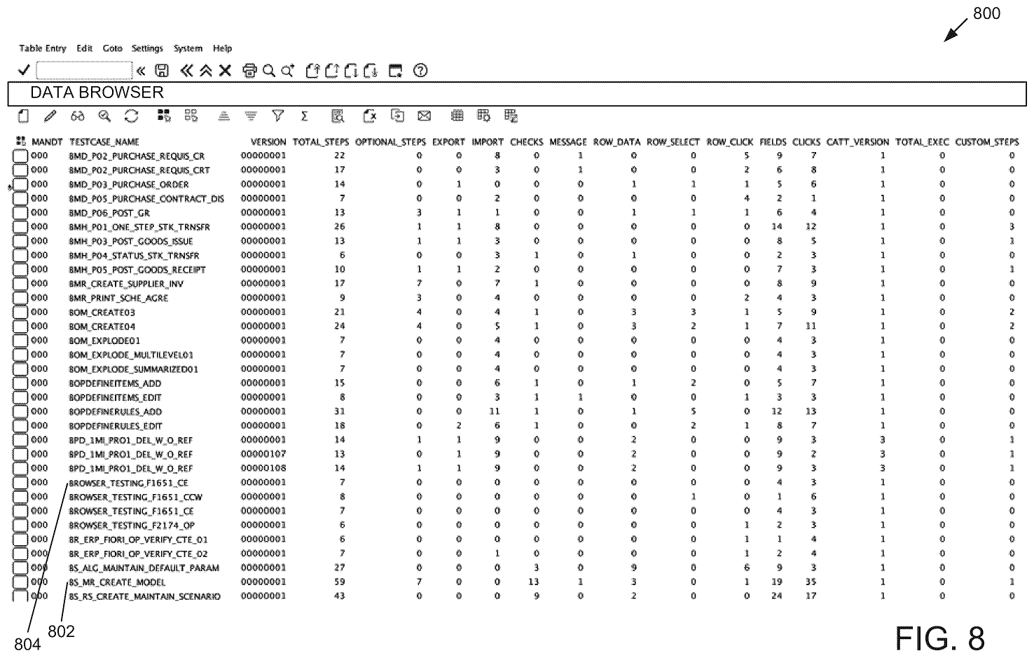

FIG. 8 is a block diagram of an example user interface 800 displaying a table listing a plurality test automates and respective values of factors which may contribute to impact quotient determinations for the test automates, and can be used in any of the examples herein. In the example, the table lists a plurality of test automates in a column entitled “TESTCASE NAME.”

The remaining columns of the table represent fields whose values may factor into a determination of an impact quotient for the corresponding test automate. In the example, these fields include a number of total steps, a number of optional steps, a number of exports performed by the test automate, a number of imports performed by the test automate, a number of checks performed by the test automate, a number of row clicks performed by the test automate, a number of field clicks performed by the test automate, etc.

As shown, a test automate 802 entitled BS_MR_CREATE_MODEL has a value of 59 for the TOTAL_STEPS field. This is a relatively high number of steps, which may perform an overall end-to-end functionality test of a software product. In addition, test automate 802 includes around 13 checks, which is a relatively high number of checks. Accordingly, test automate 802 will likely be assigned a high impact quotient.

As shown, a test automate 804 entitled BROWSER_TESTING_F1651_CE has a value of 7 for the TOTAL_STEPS field. This is a relatively small number of steps. Further, test automate 804 does not contain any imports, exports, or checks, which tends to signify a low impact test automate. Accordingly, test automate 804 will likely be assigned a low impact quotient.

### Example 12—Use Cases

The technologies described herein can be applied in a variety of scenarios.

As one example, the technologies can be integrated into on-premises or cloud software associated with platforms such as SAP S/4HANA or SAP S/4HANA Cloud available from SAP SE of Walldorf, Germany.

Test automation tools which may be used for regression and end-to-end process testing are available from SAP SE of Walldorf, Germany, as well as from third-party vendors.

### Example 13—Example Implementations

Any of the following can be implemented.

Clause 1. A computer-implemented method comprising: receiving a prompt to evaluate a test automate; responsive to the prompt: performing a software analysis of the test automate; performing an analysis of historical data of the test automate; and assigning an impact quotient to the test automate based on the software analysis, the analysis of the historical data, and a plurality of rules; comparing the impact quotient to an impact quotient threshold; and responsive to the impact quotient being below the impact quotient threshold, disabling the test automate.

Clause 2. The method of Clause 1, wherein each rule of the plurality of rules specifies a condition which, if met for the test automate, either increases or decreases the impact quotient assigned to the test automate.

Clause 3. The method of Clause 2, wherein the plurality of rules comprise at least one of: a first rule indicating that a minimum number of user actions in the test automate being below a user action threshold decreases the impact quotient assigned to the test automate; a second rule indicating that the test automate ending with a page action decreases the impact quotient assigned to the test automate; a third rule indicating that the test automate including a static value for a specified field decreases the impact quotient assigned to the test automate; or a fourth rule indicating that a number of consecutive prior executions of the test automate that resulted in failure for a same reason being above a failed execution threshold decreases the impact quotient assigned to the test automate.

Clause 4. The method of Clause 3, wherein the plurality of rules further comprises at least one of: a fifth rule indicating that the test automate including an export as a last step increases the impact quotient assigned to the test automate; a sixth rule indicating that the test automate being configured to receive an input as an import parameter increases the impact quotient assigned to the test automate; a seventh rule indicating that the test automate including one or more checks increases the impact quotient assigned to the test automate; or an eighth rule indicating that the test automate having a percentage of successful prior executions above a successful execution threshold increases the impact quotient assigned to the test automate.

Clause 5. The method of any one of Clauses 1-4, wherein performing the software analysis of the test automate comprises: determining one or more action types associated with the test automate; and assigning a level of complexity to the test automate based on the one or more action types associated with the test automate, wherein assigning a low level of complexity to the test automate decreases the impact quotient assigned to the test automate, and wherein assigning a high level of complexity to the test automate increases the impact quotient assigned to the test automate.

Clause 6. The method of Clause 5, further comprising assigning the low level of complexity to the test automate in response to at least one of: a determination that the one or more action types associated with the test automate are all click actions; or a determination that the test automate includes a number of optional actions above an optional action threshold.

Clause 7. The method of Clause 5 or Clause 6, further comprising assigning the high level of complexity to the test automate in response to at least one of: a determination that the test automate includes one or more actions that are not click actions; or a determination that the test automate does not include a number of optional actions above an optional action threshold.

Clause 8. The method of any one of Clauses 1-7, wherein performing the software analysis of the test automate further comprises: determining that the test automate is associated with at least two test types; and responsive to determining that the test automate is associated with that least two test types, increasing the impact quotient assigned to the test automate.

Clause 9. The method of any one of Clauses 1-8, wherein the performing the analysis of the historical data of the test automate comprises: determining a frequency of execution of the test automate; and comparing the frequency of execution of the test automate to an execution frequency threshold, wherein the frequency of execution of the test automate being above the execution frequency threshold increases the impact quotient assigned to the test automate, and wherein the frequency of execution of the test automate being below the execution frequency threshold decreases the impact quotient assigned to the test automate.

Clause 10. The method of any one of Clauses 1-9, wherein the performing the analysis of the historical data of the test automate comprises: determining a failure rate of the test automate over a specified time period; and comparing the failure rate to a failure rate threshold, wherein the failure rate being above the failure rate threshold decreases the impact quotient assigned to the test automate, and wherein the failure rate being below the failure rate threshold increases the impact quotient assigned to the test automate.

Clause 11. The method of any one of Clauses 1-10, further comprising: obtaining an opinion regarding the test automate from a functional expert, wherein the assigning the impact quotient to the test automate is further based on the opinion regarding the test automate from the functional expert.

Clause 12. The method of any one of Clauses 1-11, wherein the prompt is a first prompt, and wherein the impact quotient is above the impact quotient threshold, the method further comprising: receiving a second prompt to re-evaluate the test automate; responsive to the second prompt: performing an updated software analysis of the test automate; obtaining updated historical performance data for the test automate; and assigning an updated impact quotient to the test automate based on the updated software analysis of the test automate, the updated historical performance data for the test automate, and the plurality of rules; comparing the updated impact quotient to the impact quotient threshold; and responsive to the updated impact quotient being below the impact quotient threshold, disabling the test automate.

Clause 13. The method of Clause 12, wherein the second prompt is received at a predetermined interval and/or in response to a specified event.

Clause 14. The method of Clause 13, wherein the specified event is selected from the group consisting of: an edit to the test automate; a scheduled software update; or a scheduled software release.

Clause 15. A computing system comprising: at least one hardware processor; at least one memory coupled to the at least one hardware processor; a plurality of stored test automates; and one or more non-transitory computer-readable media having stored therein computer-executable instructions that, when executed by the computing system, cause the computing system to perform: receiving a request to evaluate a first test automate and a second test automate of the plurality of stored test automates; responsive to the request: assigning a first impact quotient to the first test automate based on a first plurality of factors; and assigning a second impact quotient to the second test automate based on a second plurality of factors; comparing each of the first impact quotient and the second impact quotient to an impact quotient threshold; responsive to a determination that the first impact quotient is below the impact quotient threshold, changing a status of the first test automate to disabled; and responsive to a determination that the second impact quotient is above the impact quotient threshold, maintaining an enabled status of the second test automate.

Clause 16. The system of Clause 15, wherein: the first plurality of factors comprises a plurality of static rules and at least one of: a software analysis of the first test automate; or an analysis of historical data of the first test automate, and the second plurality of factors comprises the plurality of static rules and at least one of: a software analysis of the second test automate; or an analysis of historical data of the second test automate.

Clause 17. The system of Clause 16, wherein the computer-executable instructions further comprise computer-executable instructions that implement a scheduler service, and wherein the request to evaluate the first test automate and the second test automate is received from the scheduler service at a predetermined interval and/or in response to a specified event.

Clause 18. The system of Clause 17, wherein the request is a first request, and wherein the computer-executable instructions further comprise computer-executable instructions that, when executed by the computing system, cause the computing system to perform: receiving a second request from the scheduler service to re-evaluate the second impact quotient; responsive to the second request: modifying the second impact quotient based on a third plurality of factors; and comparing the modified second impact quotient to the impact quotient threshold; and responsive to the modified second impact quotient being below the impact quotient threshold, disabling the second test automate.

Clause 19. The system of Clause 18, wherein the third plurality of factors comprises the plurality of static rules and at least one of: an updated software analysis of the second test automate; or an updated analysis of the historical data of the second test automate.

Clause 20. One or more non-transitory computer-readable media comprising computer-executable instructions that, when executed by a computing system, cause the computing system to perform operations comprising: for each test automate among a plurality of test automates: performing a software analysis of the test automate; performing an analysis of historical data of the test automate; determining an impact quotient of the test automate based on the software analysis of the test automate, the analysis of the historical data of the test automate, and a plurality of static rules, wherein each rule of the plurality of static rules specifies a condition which, if met for the test automate, either increases or decreases the impact quotient of the test automate; comparing the impact quotient of the test automate to an impact quotient threshold; and responsive to the impact quotient being below the impact quotient threshold, modifying a status of the test automate from enabled to disabled; and during a subsequent automatic testing process, executing a first subset of the plurality of test automates with an enabled status and excluding from execution a second subset of the plurality of test automates with a disabled status.

### Example 14—Example Advantages

A number of advantages can be achieved via the technologies described herein. For example, millions of test automate executions may be performed across different phases of software delivery on a continuous basis. Reducing the number of test automate execution by identifying and disabling low impact test automates can optimize the resources utilization. For example, assuming a 10% reduction in the number of automated test executions in a given delivery cycle is achieved, daily pipeline efficiency can be increased and tens of thousands of dollars in cost savings can be achieved annually.

### Example 115)—Example Computing Systems

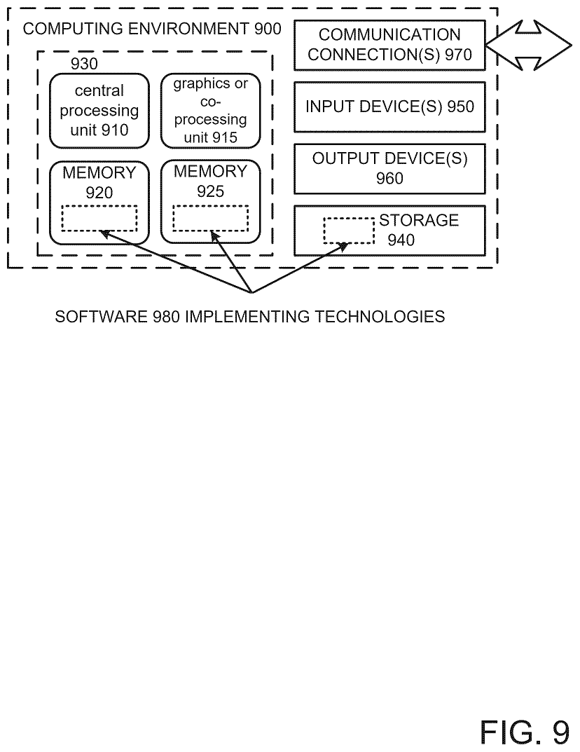

FIG. 9 depicts an example of a suitable computing system 900 in which the described innovations can be implemented. The computing system 900 is not intended to suggest any limitation as to scope of use or functionality of the present disclosure, as the innovations can be implemented in diverse computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 can be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 can have additional features. For example, the computing system 900 includes storage 940, one or more input devices 950, one or more output devices 960, and one or more communication connections 970, including input devices, output devices, and communication connections for interacting with a user. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 can be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 can be an input device such as a keyboard, mouse, pen, or trackball, a voice input device, a scanning device, touch device (e.g., touchpad, display, or the like) or another device that provides input to the computing system 900. The output device(s) 960 can be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 116)—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 117)—Example Cloud Computing Environment

FIG. 10 depicts an example cloud computing environment 1000 in which the described technologies can be implemented, including, e.g., the system 100 of FIG. 1 and other systems herein. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

In practice, cloud-based, on-premises-based, or hybrid scenarios can be supported.

### Example 18—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a prompt to evaluate a test automate;
responsive to the prompt:
performing a software analysis of the test automate;
performing an analysis of historical data of the test automate; and
assigning an impact quotient to the test automate based on the software analysis, the analysis of the historical data, and a plurality of rules;
comparing the impact quotient to an impact quotient threshold; and
responsive to the impact quotient being below the impact quotient threshold, disabling the test automate.

2. The method of claim 1, wherein each rule of the plurality of rules specifies a condition which, if met for the test automate, either increases or decreases the impact quotient assigned to the test automate.

3. The method of claim 2, wherein the plurality of rules comprise at least one of:
a first rule indicating that a minimum number of user actions in the test automate being below a user action threshold decreases the impact quotient assigned to the test automate;
a second rule indicating that the test automate ending with a page action decreases the impact quotient assigned to the test automate;
a third rule indicating that the test automate including a static value for a specified field decreases the impact quotient assigned to the test automate; or
a fourth rule indicating that a number of consecutive prior executions of the test automate that resulted in failure for a same reason being above a failed execution threshold decreases the impact quotient assigned to the test automate.

4. The method of claim 3, wherein the plurality of rules further comprises at least one of:
a fifth rule indicating that the test automate including an export as a last step increases the impact quotient assigned to the test automate;
a sixth rule indicating that the test automate being configured to receive an input as an import parameter increases the impact quotient assigned to the test automate;
a seventh rule indicating that the test automate including one or more checks increases the impact quotient assigned to the test automate; or
an eighth rule indicating that the test automate having a percentage of successful prior executions above a successful execution threshold increases the impact quotient assigned to the test automate.

5. The method of claim 1, wherein performing the software analysis of the test automate comprises:
determining one or more action types associated with the test automate; and
assigning a level of complexity to the test automate based on the one or more action types associated with the test automate,
wherein assigning a low level of complexity to the test automate decreases the impact quotient assigned to the test automate, and
wherein assigning a high level of complexity to the test automate increases the impact quotient assigned to the test automate.

6. The method of claim 5, further comprising assigning the low level of complexity to the test automate in response to at least one of:
a determination that the one or more action types associated with the test automate are all click actions; or
a determination that the test automate includes a number of optional actions above an optional action threshold.

7. The method of claim 5, further comprising assigning the high level of complexity to the test automate in response to at least one of:
a determination that the test automate includes one or more actions that are not click actions; or
a determination that the test automate does not include a number of optional actions above an optional action threshold.

8. The method of claim 1, wherein performing the software analysis of the test automate further comprises:
determining that the test automate is associated with at least two test types; and
responsive to determining that the test automate is associated with that least two test types, increasing the impact quotient assigned to the test automate.

9. The method of claim 1, wherein the performing the analysis of the historical data of the test automate comprises:
determining a frequency of execution of the test automate; and
comparing the frequency of execution of the test automate to an execution frequency threshold,
wherein the frequency of execution of the test automate being above the execution frequency threshold increases the impact quotient assigned to the test automate, and
wherein the frequency of execution of the test automate being below the execution frequency threshold decreases the impact quotient assigned to the test automate.

10. The method of claim 1, wherein the performing the analysis of the historical data of the test automate comprises:
determining a failure rate of the test automate over a specified time period; and
comparing the failure rate to a failure rate threshold,
wherein the failure rate being above the failure rate threshold decreases the impact quotient assigned to the test automate, and
wherein the failure rate being below the failure rate threshold increases the impact quotient assigned to the test automate.

11. The method of claim 1, further comprising:
obtaining an opinion regarding the test automate from a functional expert,
wherein the assigning the impact quotient to the test automate is further based on the opinion regarding the test automate from the functional expert.

12. The method of claim 1, wherein the prompt is a first prompt, and wherein the impact quotient is above the impact quotient threshold, the method further comprising:
receiving a second prompt to re-evaluate the test automate;
responsive to the second prompt:
performing an updated software analysis of the test automate;
obtaining updated historical performance data for the test automate; and
assigning an updated impact quotient to the test automate based on the updated software analysis of the test automate, the updated historical performance data for the test automate, and the plurality of rules;
comparing the updated impact quotient to the impact quotient threshold; and
responsive to the updated impact quotient being below the impact quotient threshold, disabling the test automate.

13. The method of claim 12, wherein the second prompt is received at a predetermined interval and/or in response to a specified event.

14. The method of claim 13, wherein the specified event is selected from the group consisting of:
an edit to the test automate;
a scheduled software update; or
a scheduled software release.

15. A computing system comprising:
at least one hardware processor;
at least one memory coupled to the at least one hardware processor;
a plurality of stored test automates; and
one or more non-transitory computer-readable media having stored therein computer-executable instructions that, when executed by the computing system, cause the computing system to perform:
receiving a request to evaluate a first test automate and a second test automate of the plurality of stored test automates;
responsive to the request:
assigning a first impact quotient to the first test automate based on a first plurality of factors; and
assigning a second impact quotient to the second test automate based on a second plurality of factors;
comparing each of the first impact quotient and the second impact quotient to an impact quotient threshold;
responsive to a determination that the first impact quotient is below the impact quotient threshold, changing a status of the first test automate to disabled; and
responsive to a determination that the second impact quotient is above the impact quotient threshold, maintaining an enabled status of the second test automate.

16. The system of claim 15, wherein:
the first plurality of factors comprises a plurality of static rules and at least one of:
a software analysis of the first test automate; or
an analysis of historical data of the first test automate, and
the second plurality of factors comprises the plurality of static rules and at least one of:
a software analysis of the second test automate; or
an analysis of historical data of the second test automate.

17. The system of claim 16, wherein the computer-executable instructions further comprise computer-executable instructions that implement a scheduler service, and wherein the request to evaluate the first test automate and the second test automate is received from the scheduler service at a predetermined interval and/or in response to a specified event.

18. The system of claim 17, wherein the request is a first request, and wherein the computer-executable instructions further comprise computer-executable instructions that, when executed by the computing system, cause the computing system to perform:
receiving a second request from the scheduler service to re-evaluate the second impact quotient;
responsive to the second request:
modifying the second impact quotient based on a third plurality of factors; and
comparing the modified second impact quotient to the impact quotient threshold; and
responsive to the modified second impact quotient being below the impact quotient threshold, disabling the second test automate.

19. The system of claim 18, wherein the third plurality of factors comprises
the plurality of static rules and at least one of:
an updated software analysis of the second test automate; or
an updated analysis of the historical data of the second test automate.

20. One or more non-transitory computer-readable media comprising computer-executable instructions that, when executed by a computing system, cause the computing system to perform operations comprising:
for each test automate among a plurality of test automates:
performing a software analysis of the test automate;
performing an analysis of historical data of the test automate;
determining an impact quotient of the test automate based on the software analysis of the test automate, the analysis of the historical data of the test automate, and a plurality of static rules, wherein each rule of the plurality of static rules specifies a condition which, if met for the test automate, either increases or decreases the impact quotient of the test automate;
comparing the impact quotient of the test automate to an impact quotient threshold; and
responsive to the impact quotient being below the impact quotient threshold, modifying a status of the test automate from enabled to disabled; and
during a subsequent automatic testing process, executing a first subset of the plurality of test automates with an enabled status and excluding from execution a second subset of the plurality of test automates with a disabled status.
